(19) United States
(12) Patent Application Publication
(10) Pub. No.: US 2024/0345575 A1
(43) Pub. Date: Oct. 17, 2024

(54) AQUATIC INSTALLATION PREDICTIVE MAINTENANCE SYSTEM AND METHOD

(71) Applicant: PCFR SAS, Cucuron (FR)

(72) Inventors: Lane Hoy, Vaugines (FR); Xavier Darok, Verquieres (FR); Sebastien Ettling Coeffier, Cabrières d'Aigues (FR); Rene Brunier, Vaugines (FR); Lucas Dupuis, LILLE (FR)

(21) Appl. No.: 18/299,935

(22) Filed: Apr. 13, 2023

(51) Int. Cl. G05B 23/02

(52) U.S. Cl. CPC G05B 23/0283

(57) ABSTRACT

The aquatic installation predictive maintenance system (100) comprises:
at least one physical/chemical sensor (110, 115, 116, 117, 181, 182, 183, 184) interacting with water in at least one aquatic installation and configured to provide series of at least one sensed value representative of a physical/chemical parameter, and
at least one processor (120) configured to execute instructions representative of the steps of:
   operating a trained machine learning model, said model being trained to associate, for at least one series of sensed value representative of a physical/chemical parameter, at least one aquatic installation operational degradation event associated with a date of event occurrence, and
   determining a sequence of maintenance operations to be performed on at least one aquatic installation as a function of at least one predicted aquatic installation operational degradation event and associated date of event occurrence.

### TECHNICAL FIELD OF THE INVENTION

The present invention relates to an aquatic installation predictive maintenance system and an aquatic installation predictive maintenance method. It applies, in particular, to the field of physical and chemical water treatment and to the field of in situ physical and chemical water treatment. The present invention applies to commercial and residential recreational aquatics (pools, spas, spray pads, water features, water fountains, water parks, wellness facilities, therapy facilities, lazy rivers, etc.) and to any similar industry or market segment where water is treated and/or monitored in a semi closed and/or closed circuit (such as waste water, water reuse, industrial water, drinking water, animal water, etc.) and to any similar industry or market segment where water is used as part of the process (such as evaporative cooling for energy generation and data centers, heating, ventilation and air conditioning, and fire suppression stored water management, etc.).

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In current digital aquatic installation control and monitoring systems, such as swimming pool control and monitoring systems, alerts associated with a need of maintenance of such installations are emitted as a function of the value of an operational parameter of an element associated to the aquatic installation and a corresponding alert threshold. Such an operational parameter may correspond to, for example, the need to change an empty consumable's installation, to clean the installation and/or the filter, or to maintain a circulation pump.

Such systems function on an element-by-element basis and are linear in their ways of functioning, considering they are limited to the comparison of an operational parameter value to a threshold to determine a need for intervention and/or maintenance.

However, operational parameters of aquatic facilities interact with each other, which renders linear control and monitoring systems inaccurate considering that an aquatic installation condition may deteriorate faster than anticipated by traditional and linear control and monitoring systems. To counteract such shortcomings, the alert threshold values are typically compensated, which leads to earlier than necessary alerts and, in the worst case, a lack of consideration by users for such alerts which may be deemed too conservative.

Furthermore, such systems typically stop at the emission of alerts, and the actual maintenance of the aquatic installation is processed outside of these systems. Therefore, the maintenance may or may not be performed, which in any case does not interact with these systems beyond the fact that monitored value may or may no longer trigger an alert if the maintenance of the cause of the alert was properly addressed.

All of these systems are thus unsatisfactory in regards of the timeliness and accuracy of aquatic installation maintenance, as well as in terms of capacity to monitor the state and maintenance operations linked with an aquatic installation or an ensemble of such aquatic installations, as well as in terms of capacity to manage the needs and use of consumable resources to maintain an ideal water state in compliance with user's and/or operator's set points (such as energy consumption, water consumption, and consumption for associated chemical treatment). For users in charge of dozens or hundreds of such aquatic installations, these problems compound to generate significant waste of maintenance operator time, as well as significantly increase the risk of maintenance requirements not being fulfilled on time, leading to health and safety risk to users and maintainers and permanent degradation of the aquatic installations, as well as significantly increasing the operating cost with an excess of needs and/or use of consumable resources to maintain an ideal water state in compliance with user's and/or operator's set points (such as energy consumption, water consumption, and consumption for associated chemical treatment).

### SUMMARY OF THE INVENTION

The present invention aims at overcoming the above-mentioned drawbacks as well as other drawbacks that could be overcome although not mentioned in the description below.

The inventors have discovered that using a trained machine learning model to predict a risk of occurrence of a negative and/or damaging event and/or of an increase of consumable use and/or need (such as energy consumption, water consumption, and consumption for associated chemical treatment) in an aquatic installation, either relative to the water in the installation and/or to the installations itself and/or to the installed equipment, associated with a maintenance job scheduling capacity, allow for proactive and time-optimized and/or cost-optimized maintenance, and health and safety risk to users and maintainers.

Such a machine learning model may be trained on a variety of data, both internal to the water or the installation and external.

Such data may originate from a variety of sensors and data sources.

In particular, such sensors may be embedded into installed equipment, and floating and/or submersible mobile vehicles, that operate within aquatic installations.

In particular, such sensors may correspond to specific total alkalinity measurement devices.

In particular, such data sources may correspond to network and internet databases and data sources.

### BRIEF DESCRIPTION OF THE DRAWINGS

Other advantages, purposes and particular characteristics of the invention shall be apparent from the following non-exhaustive description of at least one particular system and method object of this invention, in relation to the drawings annexed hereto, in which:

FIG. 1 represents, schematically, a particular embodiment of a system object of the present invention,

FIG. 2 represents, schematically and in the form of a flowchart, a first particular succession of steps of a method object of the present invention,

FIG. 3 represents, schematically, a particular embodiment of a submersible vehicle used in the system object of the present invention,

FIG. 4 represents, schematically, a particular embodiment of a floating vehicle used in the system object of the present invention,

FIG. 5 represents, schematically, a first view of a particular sensor that can be used in the system object of the present invention,

FIG. 6 represents, schematically, a second view of a particular sensor that can be used in the system object of the present invention,

FIG. 7 represents, schematically, a graph representing a succession of pH measurements at the boundary layer of a body of water for different total alkalinity values,

FIG. 8 represents, schematically and in the form of a flowchart, a second particular succession of steps of a method object of the present invention, and

FIG. 9 represents, schematically, a computing system capable of performing a method object of the present invention.

### DETAILED DESCRIPTION OF THE INVENTION

This description is not exhaustive, as each feature of one embodiment may be combined with any other feature of any other embodiment in an advantageous manner.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

According to at least one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

According to at least one embodiment, the present invention makes use of software, stored as instructions in a memory, ROM or storage that may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor. While each processor or core of the processor executes a single task at a time, computer system may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

It should be noted that the figures are not to scale.

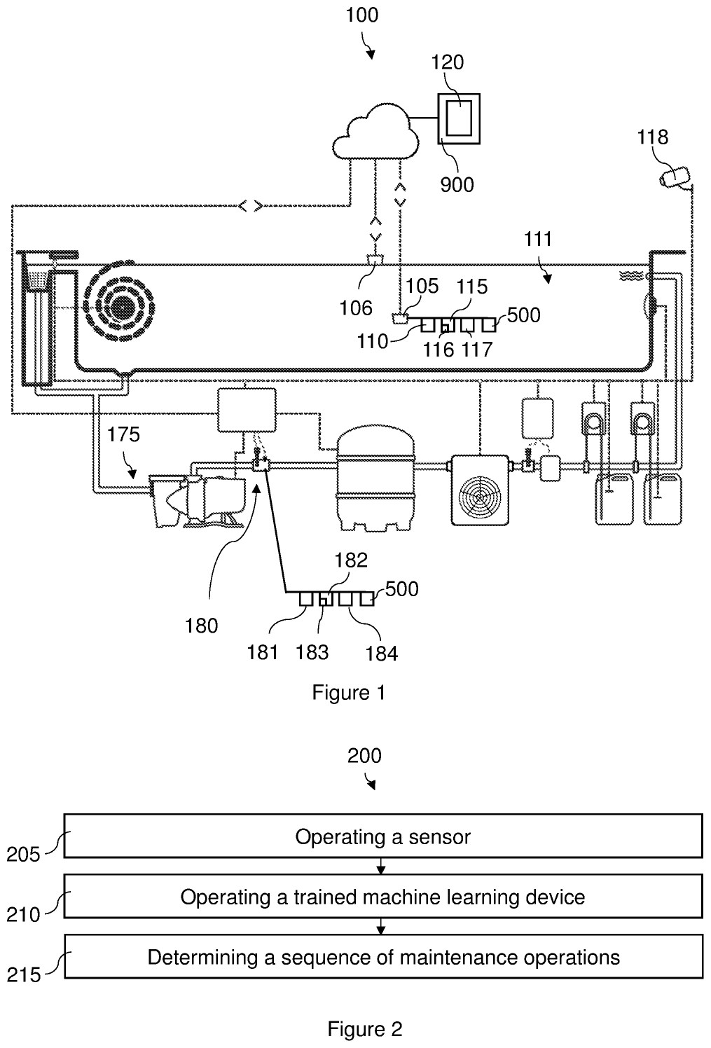

FIG. 1 represents, schematically, a particular embodiment of the system 100 object of the present invention. This aquatic installation predictive maintenance system 100 may comprise:
at least one physical/chemical sensor, 110, 115, 116, 117, 181, 182, 183, and 184, interacting with water in at least one aquatic installation and configured to provide series of at least one sensed value representative of a physical/chemical parameter, wherein, for example:
   at least one physical/chemical sensor, 181, 182, 183 and/or 184, is situated in an analysis chamber 180, or in a pipe of a circulation system where water flows, interacting with water in at least one aquatic installation and configured to provide series of at least one sensed value representative of a physical/chemical parameter and
   at least one physical/chemical sensor, 110, 115, 116, and/or 117, is situated in a submersible vehicle (ROV) 105 and/or a floating vehicle 106, interacting with water in at least one aquatic installation and configured to provide series of at least one sensed value representative of a physical/chemical parameter, and
at least one processor 120 configured to execute instructions representative of the steps of:
   operating a trained machine learning model, said model being trained to associate, for at least one series of sensed value representative of a physical/chemical parameter, at least one aquatic installation operational degradation event associated with a date of event occurrence, and
   determining a sequence of maintenance operations to be performed on at least one aquatic installation as a function of at least one predicted aquatic installation operational degradation event and associated date of event occurrence.

The physical and/or chemical sensor, 110, 115, 116, 117, 181, 182, 183 and/or 184, is intended in the broadest sense, meaning that any physical and/or chemical parameter sensing device is encompassed, provided the output data of such a device is used to evaluate the physical and/or chemical state of the water in a installation 111 and/or the physical and/or chemical state of the installation 111, and/or status of equipment in the aquatic installation.

Such a physical and/or chemical sensor, 110, 115, 116, 117, 181, 182, 183 and/or 184, is configured to sense a value of a physical and/or chemical parameter at a specific time, allowing for a succession of values sensed to be associated into a series. Such an association may be performed by the physical and/or chemical sensor, 110, 115, 116, 117, 181, 182, 183 and/or 184, or by a computing device receiving a succession of data representative of the values sensed by said physical and/or chemical sensor, 110, 115, 116, 117, 181, 182, 183 and/or 184.

Such a physical and/or chemical sensor, 110, 115, 116, 117, 181, 182, 183 and/or 184, may correspond to but is not limited to:
a pH sensor, and/or
a total alkalinity sensor, and/or
a conductivity sensor, and/or
an oxidation-reduction potential sensor, and/or
a turbidity sensor, and/or
an optical sensor, and/or
a camera and/or video camera, and/or
an acoustic and/or sonar sensor, and/or
a temperature sensor, and/or
a flow sensor, and/or
a water movement sensor, and/or
a pressure sensor.

In particular embodiments, such as the one shown in FIG. 1, at least one physical/chemical sensor, 110, 115, 116, 117, 118, 181, 182, 183 and/or 184, is associated with geographical coordinates, the step 215 of determining a sequence being configured to further determine a sequence as a function of geographical coordinates of aquatic facilities associated with at least one predicted aquatic installation operational degradation event.

This sensor to geographical coordinates may be pre-set by a user or automatically determined by using a geolocation device, such as a GPS sensor, and/or accelerometer, for example.

In particular embodiments, such as the one shown in FIG. 1, the system 100 object of the present invention comprises at least one physical/chemical sensor is an aquatic total alkalinity measurement device 500, comprising:
a pH probe 505 configured to measure pH at the boundary layer of a body of water,
optionally, a floating reference device 510 in proximity of the pH probe,
a probe controller 515, configured to sequentially activate and deactivate, or connect and disconnect, the pH probe,
a pH measurement variation detection device 520, configured to detect a variation of pH measurement in a sequence of pH probe measurements, and
an aquatic total alkalinity value determination device 525, configured to determine an aquatic total alkalinity value of the body of water as a function of the pH measurement variation detected.

The pH probe 505 can be of any type known to a person skilled in the art that is suited for the particular implementation and intended use of the system 500. Such a pH probe 505 may differ in nature depending on the context of use of the system 500. For example, in an aquatic facility, the pH probe 505 may comprise an oxidation-reduction potential sensor 535.

The objective of the pH probe 505 is to allow for the reproductible measurement of the pH in a body of water. Such a pH probe 505 is typically electronic and requires the supply of electrical energy to function. Such a pH probe 505 may further comprise a digital switch, allowing for the selective activation/deactivation of at least part of the core components of the pH probe 505.

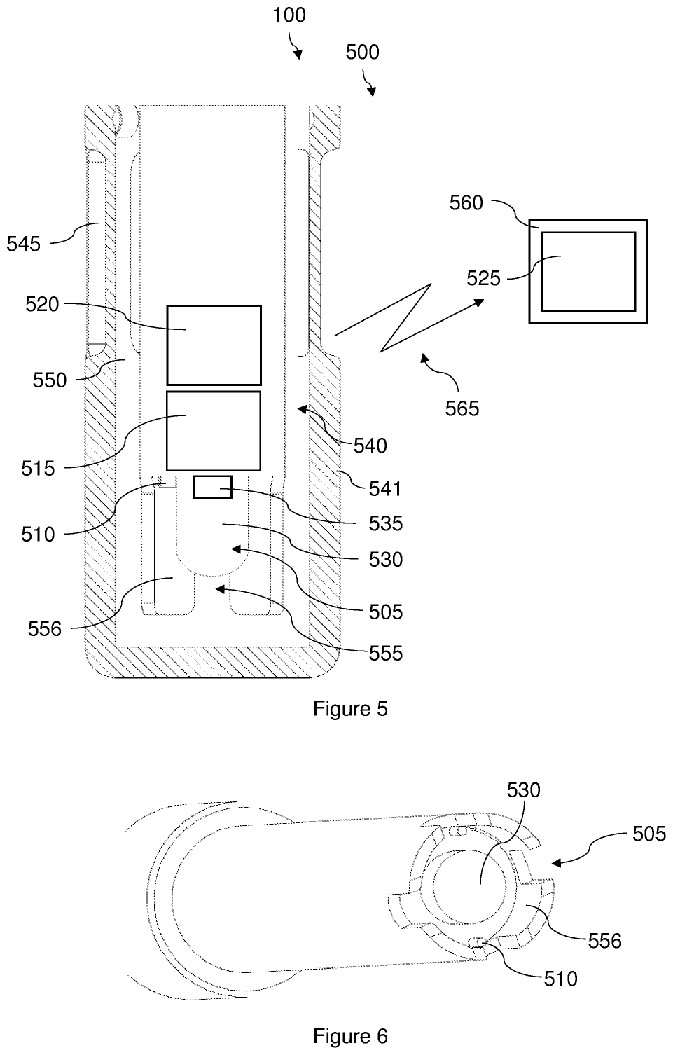

The pH probe 505 may be mechanically located at the distal end of a sensor body, such as shown in FIGS. 5 and 6. The purpose of such a sensor body is the insertion in the body of water and, in preferred embodiments, within an analysis chamber 540.

The reference floating device 510, sometimes called “solution earth” or “liquid junction”, can correspond to any electrically conductive electrode or pin configured to normalize the signal sensed by the pH probe 505, avoiding electric noise in the proximity of the pH probe 505.

In the example shown in FIGS. 5 and 6, the reference floating device 510 comprises two electrodes, each located on a different side of a sensor 535 of the probe 505. Such electrodes may be diametrically opposed, with the sensor 535 acting as the center of a circle in which both electrodes are located on the periphery of said circle, for example. Such electrodes and the sensor 535 may be geometrically aligned.

In particular embodiments, such as the one shown in FIG. 5, the pH probe 505 comprises:
optionally, the floating reference device 510,
a microporous glass bulb membrane 530, and
an oxidation-reduction potential sensor 535.

pH measurement is based on the relationship between the concentration of H+ ions in tested water and the difference in electrochemical potential which is established in the lead-free glass bulb membrane of the probe. This lead-free bulb is specifically designed to be selective to H+ ions concentration.

In general, the pH probe 505 is made of a simple electronic amplifier and a combined electrode, which consists of two electrodes: one whose potential is known and constant and the other whose potential varies with the pH.

Once the probe 505 is in contact with water, the H+ ions exchange on the glass bulb, creating an electrochemical potential across the bulb. The electronic amplifier detects the difference in electrical potential between the two electrodes generated in the measurement and converts the potential difference to pH units.

The pH value is determined by correlation because the potential difference between the two electrodes evolves proportionally to the pH according to the Nernst equation.

The probe controller 515 is, for example, an electronic circuit configured to electrically or electronically activate and deactivate, or connect and disconnect, the pH probe 505 or the sensor of said pH probe 505. Such an activation/deactivation or connection/disconnection may be performed by cutting and restoring power supply to the pH probe 505 or sensor or by emitting an activation/deactivation or connection/disconnection command to said pH probe 505 or sensor or relay.

The terms “activate and deactivate” relate to any hardware or software level activation/deactivation and/or to the connection/disconnection of the pH probe 505.

The probe controller 515 may itself be activated as a function of a command emitted by a computing device, located on site and mechanically connected to the pH probe 505 and/or the probe controller 515 or remotely located and connected to the probe controller 515 by way of a data connection.

The probe controller 515 may comprise, for example, a computer software executed upon a computing device, said computer software triggering the activation/deactivation or connection/disconnection of the pH probe 505. Such a computer software may correspond, for example, to a particular firmware or driver. Such a computer software may be updated remotely and such an update may be automatically installed in the system 500.

The probe controller 515 may be configured to activate or connect the pH probe 505 periodically. The pH probe may be activated or physically connected, for example, every 60 seconds. Such an activation or physical connection may be conditional, for example to the activation of a water displacement pump. The rate of measurement may be variable depending on a mode configured. The duration of measurement may depend on the water's stability, so the pH measurement last until the measured pH is sufficiently stable.

Such an activation/deactivation may be performed by an electronic relay.

The pH measurement variation detection device 520 is, for example, an electronic device associated with the pH probe 505, configured to record a succession of pH values measured by the pH probe 505 and to compute, from said succession, a measurement variation value. Such a measurement variation value may be computed by the subtraction of a recent value from an older value.

The measured variation may be performed on immediately subsequent measured pH values or be sampled according to a particular sampling rule. Such variation may also be performed on an aggregate values of measured pH values.

For example, the pH measurement variation detection device 520 may be configured to subtract the average measured pH value during a specific, more recent timeframe from the average measured pH value during a specific, older timeframe.

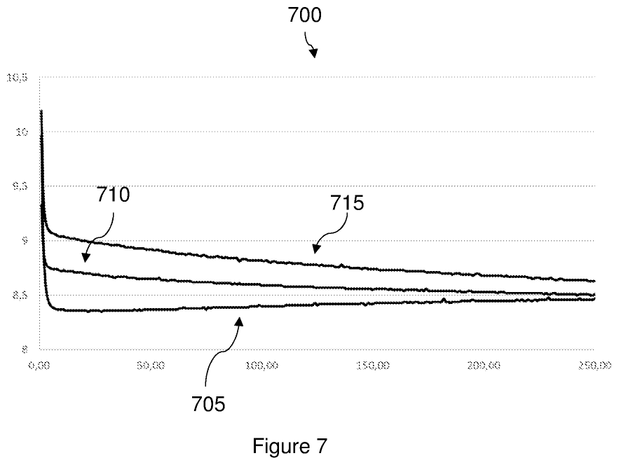

For example, the pH measurement variation detection device 520 may be configured to compute determine a mathematical function fitting a succession of data points linking measured pH to time of measurement since an initial measurement. Such an example is shown in FIG. 7. In other examples, the pH measurement variation detection device 520 may be configured to store, in a memory, a succession of data points linking measured pH to time of measurement since an initial measurement.

The system 500 may further comprise a timestamping means, configured to associate a time of measurement to a sensed pH value by the pH probe 505.

The action of repeatedly measuring the pH in the same water sample induces variations in the measurement of pH, the magnitude of these variations being dependent on the total alkalinity of the water. Such a pH measurement variation detection device 520 may also correspond to a computer software executed upon a computing device.

The pH measurement variation detection device 520 may operate remotely from the pH probe 505. In such a case, the system 500 may further comprise a communication means 565 to transmit data from the pH probe 505 to the pH measurement variation detection device 520. In such a case, the pH measurement variation detection device 520 may correspond to a computer program executed by a computing server, accessible on the cloud, via a data network such as the Internet for example.

The aquatic total alkalinity value determination device 525 is, for example, an electronic device associated with the pH measurement variation detection device 520, configured to associate a total alkalinity value to the measured variation.

For example, the total alkalinity value determination device 525 may be configured to compute the derivative of a mathematical function fitting a succession of data points linking measured pH to time of measurement since an initial measurement. Such an example is shown in FIG. 7.

The total alkalinity value determination device 525 may be configured to associate, with specific or ranges of said derivatives, a specific or a range of total alkalinity value.

For example, in FIG. 7:
a first series 805 of pH measurements (Y-axis), at specific times (X-axis), measured in minutes, since an initial measurement, for a total alkalinity value of 220 mg/l,
a second series 810 of pH measurements (Y-axis), at specific times (X-axis), measured in minutes, since an initial measurement, for a total alkalinity value of 125 mg/l, and
a third series 815 of pH measurements (Y-axis), at specific times (X-axis), measured in minutes, since an initial measurement, for a total alkalinity value of 19 mg/l.

Obtaining such series linking pH to alkalinity value relationship can be performed by empirically measuring, for different values of total alkalinity and a determined activation/connection frequency for the pH sensor, values of pH in the boundary layer of a body of water and storing these series in a memory. The number of such tests to be performed is limited in terms of scope, considering the limited number of values for alkalinity.

Such a total alkalinity value may be a mathematical function of the measured variation. Such a mathematical function may be performed by determining a regression function based upon the pH series captured, or derivative values of these series, as well as the operational parameters associated with the capture.

Such derivative values may be, for example, any type of averages or parameters of derivative functions.

For example, the following mathematical formula may be used (with initial parameters values: pH=7.4; water temperature=20° C.; ORP=700 mV; flow rate=0 m³/h):

$$Alk = - 0.0001 ( A V {G}_{1} - {AVG}_{2} ) + 0.1468$$

Where:
Alk designates the total alkalinity value,
AVG₁ designates the average pH values measured from 20 seconds to 80 seconds after the initial measurement,
AVG₂ designates the average pH values measured from 300 seconds to 360 seconds after the initial measurement,

Such a function may be approximated to Alk=(AVG₁−AVG₂).

From such a function, the following correspondence table may be obtained:

| Total alkalinity value | AVG₁ − AVG₂ |
|---|---|
| 10 | 0.1368 |
| 20 | 0.1268 |
| 30 | 0.1168 |
| 40 | 0.1068 |
| 50 | 0.0968 |
| 60 | 0.0868 |
| 70 | 0.0768 |
| 80 | 0.0668 |
| 90 | 0.0568 |
| 100 | 0.0468 |
| 110 | 0.0368 |
| 120 | 0.0268 |
| 130 | 0.0168 |
| 140 | 0.0068 |
| 150 | −0.0032 |
| 160 | −0.0132 |
| 170 | −0.0232 |
| 180 | −0.0332 |
| 190 | −0.0432 |
| 200 | −0.0532 |

Such a total alkalinity value may be determined as a function of the measured variation and a preset threshold value, representative of a particular total alkalinity value.

Such an aquatic total alkalinity value determination device 525 may also correspond to a computer software executed upon a computing device.

The aquatic total alkalinity value determination device 525 may operate remotely from the pH probe 505 and/or the pH measurement variation detection device 520. In such a case, the system 500 may further comprise a communication means 565 to transmit data from the pH measurement variation detection device 520 to the aquatic total alkalinity value determination device 525. In such a case, the aquatic total alkalinity value determination device 525 may correspond to a computer program executed by a computing server, accessible on the cloud, via a data network such as the Internet for example.

In particular embodiments, the pH probe controller 515 is configured to sequentially activate and deactivate, or connect and disconnect, the pH probe 505 in a body of water with no flow. Such a state may be reached by stopping a pumping system introducing water in the body of water. In particular variants, the pH probe 505 may be activated after an absence of flow is detected (by a flow sensor, for example). In particular variants, a chamber in which the pH probe 505 is located may comprise valves that may be closed prior to the operation of the pH probe 505 activation/deactivation or connection/disconnection sequence.

The terms “body of water with no flow” designate a body of water with limited water flowing. In such a body of water, the water may circulate, but limited new water may enter.

In particular embodiments, the pH probe 505 is configured to be positioned in a small-volume body of water. Such a small volume may correspond to, for example, 1 to 2 milliliters.

The terms “small-volume body of water” designate a body of water in which the chemical reaction taking place during an interval of deactivation/activation, or connection/disconnection, of the pH probe 505 provides significant impact on the pH measure so as to show a variation between two successive measurements of the pH by the pH probe 505.

In particular embodiments, the system 500 object of the present invention comprises an analysis chamber 540, comprising an opening 545, a main volume 550 connected to the opening 545 and a recess 555 in the main volume 550, the pH probe 505 being in contact with the water in the recess 555.

The analysis chamber 540 may comprise a sensor housing 541 delimiting an internal volume in which the pH probe 505 or a sensor body associated with said pH probe 505 may be inserted.

The analysis chamber 540 is preferably configured to limit the flow of water and the volume of water in proximity of the pH probe 505. Such a configuration may be performed by selecting dimensions that limit the quantity of water entering the analysis chamber 540.

The analysis chamber 540 comprises an opening 545, of arbitrary dimensions, which allows for the passage of water from the body of water to the proximity of the pH probe 505.

The analysis chamber 540 comprises a main volume 550, defined for example by the interior dimensions of the sensor housing 541.

The analysis chamber 540 comprises a recess 555, defined by a subset of the interior dimensions of the sensor housing 541. In particular embodiments, the recess 555 is formed by crenellated sensor body extensions 556 associated to the pH probe 505, said crenellated sensor body extensions 556 limiting the movement of water in the proximity of the pH probe 505.

There are many possible configurations of the analysis chamber 540. Such configurations preferably limit the quantity of water in proximity of the pH probe 505 and/or limit the movement of water in proximity of the pH probe 505.

In particular embodiments, the system 500 object of the present invention comprises a remote computing device 560 comprising the aquatic total alkalinity value determination device 525 and a communication means 565 between the pH measurement variation detection device 520 and the aquatic total alkalinity value determination device 525.

Such a remote computing device 560 may correspond to, for example, a computing server hosted remotely and accessible through a data network, such as the Internet for example.

In particular embodiments, the aquatic total alkalinity value determination device 525 operates an algorithm and/or a trained machine learning model to associate an aquatic total alkalinity value with a variation in measured pH.

In particular embodiments, the pH probe 505 is configured to measure the pH of the body of water in an aquatic facility.

In particular embodiments, the pH probe 505 is configured to measure the pH of the body of water in a pipe.

In particular embodiments, such as the one shown in FIG. 1, the system 100 object of the present invention comprises a submersible and/or floating vehicle 105, 106, comprising at least one said physical/chemical sensor, 110, 115, 116, and/or 117, configured to provide a measure of a local physical/chemical parameter in the proximity of the submersible and/or floating vehicle.

The submersible and/or floating vehicle, 105 and/or 106, may correspond, for example, to any manually, remotely and/or automatically dirigible vehicle adapted to the particular use case.

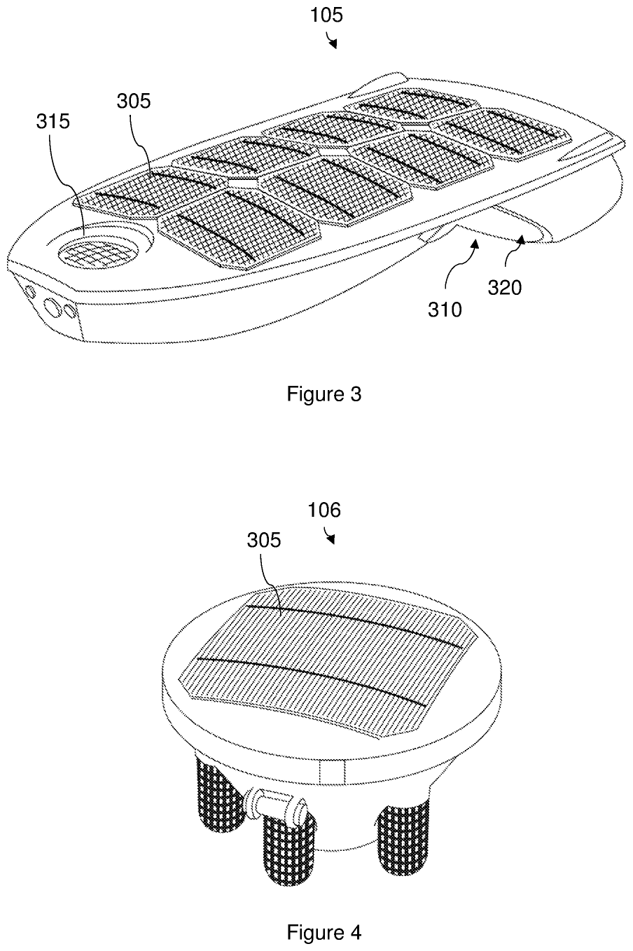

The vehicle 105 may correspond to a remotely or autonomously dirigible submarine vehicle, for example, such as shown in FIG. 3.

The vehicle 106 may also correspond to a floating device, such as shown in FIG. 4.

In particular embodiments, such as the one shown in FIG. 1, the system 100 comprises both a submersible vehicle (ROV) 105 and a floating vehicle 106.

In particular variants, at least one submersible and/or floating vehicle, 105 and/or 106, comprises a solar panel 305 configured to power an autonomous electricity source (not represented) and/or to charge the onboarded batteries (not represented).

In particular variants, at least one submersible and/or floating vehicle, 105 and/or 106, comprises an induction current collector configured to power an autonomous electricity source (not represented).

In particular variants, at least one submersible and/or floating vehicle, 105 and/or 106, comprises a power inlet configured to be connected to a charging wire to power an autonomous electricity source (not represented).

In particular variants, at least one submersible and/or floating vehicle, 105 and/or 106, comprises a propulsion 310 system, such as an engine associated with a boat propeller. Such a propulsion 310 system allows for the vehicle, 105 and/or 106, to move around in the water of the installation 111. This propulsion system 310 may comprise rear propellers 320, configured to generate forward, backward or yaw movements, and a front propeller 315, configured to generate upward or downward movements.

Such a submersible and/or floating vehicle, 105 and/or 106, may further comprise a relative positioning coordinates acquisition means, configured to locate, in a three-dimensional space representative of the aquatic installation 111, the submersible vehicle, 105 and/or 106, and to provide the corresponding coordinates of the submersible and/or floating vehicle, 105 and/or 106.

Such a relative positioning coordinates acquisition means is, for example, an acoustic and/or sonar configured to provide distance values from edges of the installation 111. The distance values allow for the determination of the shape of the installation 111. Once the shape of the installation 111 is known, such distance values allow for the determination of the positioning of the submersible and/or floating vehicle, 105 and/or 106, within said installation 111.

In another variant, the relative positioning coordinates acquisition means is, for example, a mechanical sensor used in coordination with a propulsion system 310 to map the shape of the installation 111 by detecting collisions of the submersible and/or floating vehicle, 105 and/or 106, with the edges of this installation 111.

Once the shape of the installation 111 is known, information originating from original parameters of the propulsion system 310 may be used to locate the submersible and/or floating vehicle, 105 and/or 106. For example, a duration of use of the propulsion system 310, associated with a power of propulsion, may be used in a calculation to determine a distance of the submersible and/or floating vehicle, 105 and/or 106, from the last known location.

The data resulting from the physical and/or chemical sensing means 110 and the relative positioning coordinates acquisition means may be aggregated to form a timestamped water physical and/or chemical value sensed. This data may further be associated with environmental context values, such as water pressure or time of capture for example.

In particular variants, the submersible and/or floating vehicle, 105 and/or 106, comprises an aquatic installation local physical and/or chemical state information aggregation means.

The aquatic installation local physical and/or chemical state information aggregation means is, for example, a computer software executed upon a computing device. This computing device is configured to associate, in a memory, the data resulting from the relative positioning coordinates acquisition means, the physical and/or chemical sensing means 110 and a timestamping means.

Such an association may be performed by concatenating said data in a single data stream or data frame or by creating a link between said data if such data is stored in separate database tables for example.

The timestamping means may correspond, for example, to any electronic clock used by a computing device. Such a timestamping means may be integrated into the submersible and/or floating vehicle, 105 and/or 106, or be remotely located from said submersible and/or floating vehicle, 105 and/or 106. By remotely located, it is intended that the timestamping means is linked with the submersible and/or floating vehicle, 105 and/or 106, by a communication means, such as a peer-to-peer link or a communications network link, such as the Internet for example.

The submersible and/or floating vehicle, 105 and/or 106, may further comprise an optical sensor 115, configured to provide a graphical representation of the water and/or aquatic installation, said representation being used during the step of operating the trained machine learning model.

Such an optical sensor 115 corresponds, for example, to a camera or to a video camera configured to capture images of the installation 111 and/or the water in the installation 111. In particular embodiments, this camera and/or video camera can be used to capture pictures and/or videos of the floor and walls of an aquatic reservoir to detect spots and define their origin and/or nature based on the color, location and form of said spots. In particular embodiments, this camera and/or video camera can be used to determine the water transparency and/or turbidity by analyzing the acquisition resolution and or restitution of a specific target point and/or target device location in a specific place in the pool. In particular embodiments, this target point and/or target device could be the inductive charging plate, and/or the installation's walls and/or floor, and/or a dedicated device placed in a defined location.

In particular embodiments, such as the one represented in FIG. 1, the optical sensor 115 comprises an infrared sensor 116. In particular embodiments, the infrared sensor 116 can allow the acquisition of thermic images, allowing the determination of an evolution of a water temperature evolution and/or differences within the installation. In particular embodiments, said temperatures evolution and/or differences can be registered and associated to the location to create a temperature mapping according to three axes according to times of measurement. In particular embodiments, this map can be used to adjust the water temperature homogeneity in the installation by, for example, adjusting the flow rate of the filtration pump and/or the filtration operating time and/or the operating time of the heat pump and/or the temperature set point of the heat pump and/or filter cleaning process, by increasing or decreasing their values to reach the targeted temperature homogeneity in the installation.

In particular embodiments, such as the one represented in FIG. 1, the submersible and/or floating vehicle, 105 and/or 106, comprises an acoustic and/or sonar sensor 117.

Based on the sound modifications perceived by the acoustic and/or sonar sensor, notifications and/or alerts can be emitted and/or equipment operating set point can be adjusted automatically.

For example, a pump which starts operating provides a specific sound (vibrating signature), these vibrations follow the water flow into the installation 111. Therefore, the use of an acoustic and/or sonar sensor allows for the measurement and analysis of these vibrations. Any change in this signature thus results from an interaction and/or a problem which has occurred between the pump and the installation 111. Such an interaction may correspond to a non-activation of the pump, a pump surge, a pump cavitation, an object/pollution in the pipe, a leak or a product injection. By measuring a difference between the normal state sound and the current measured sound, the diagnostic can be made, and/or notifications and/or alerts can be emitted and/or equipment operating set point can be adjusted automatically. This difference can also be linked to other types of data collected.

Any sound that may occur in the installation 111 can be linked to a type, or class, of event. The determination of this class can be obtained by using a trained machine learning classifier model. Such a trained machine learning classifier model can be obtained by feeding, in a machine learning classifier device, a sample comprising sounds and the related events. Such a trained machine learning classifier model can be obtained by feeding, in a machine learning classifier device, a sample comprising the sound in installations in the absence of an event (or anomaly), the sound in installations after an event and the related events.

Such a sound may correspond to a bather diving, an object entering in the water installation, an object's presence in the installation's pipe, rain drops, bathers swimming or playing, air release under the water's surface, overflow problems, full skimmer baskets, different flow rate or an opening/closing of the cover, presence of an automatic cleaner operating.

This sound-based alert system may be used to detect a bather in distress and/or drowning.

In particular embodiments, such as the one shown in FIG. 1, the system 100 object of the present invention comprises an external parameter sensor 118, the trained model being configured to associate, for at least one series of sensed value representative of a physical/chemical parameter and at least one series of external parameter sensed, at least one aquatic installation operational degradation event associated with a date of event occurrence.

Such an external parameter sensor 118 may correspond to any physical/chemical sensor, such as a camera and/or a video camera taking picture and/or filming the installation 111, or digital sensor, such as a connector to a weather forecasting API configured to provide data representative of current or future weather in the proximity of the installation 111.

Such an external parameter sensor 118 may be configured to sense values representative of weather conditions, and/or air pollution, and/or a number of bathers in the aquatic installation, and/or air temperature, and/or water temperature, and/or movement detection, and/or face recognition, and/or a color change detection, and/or spots and/or stain detection in the installation, and/or size detection, and/or form acquisition and/or detection, and/or contrast detection within the installation's water for example.

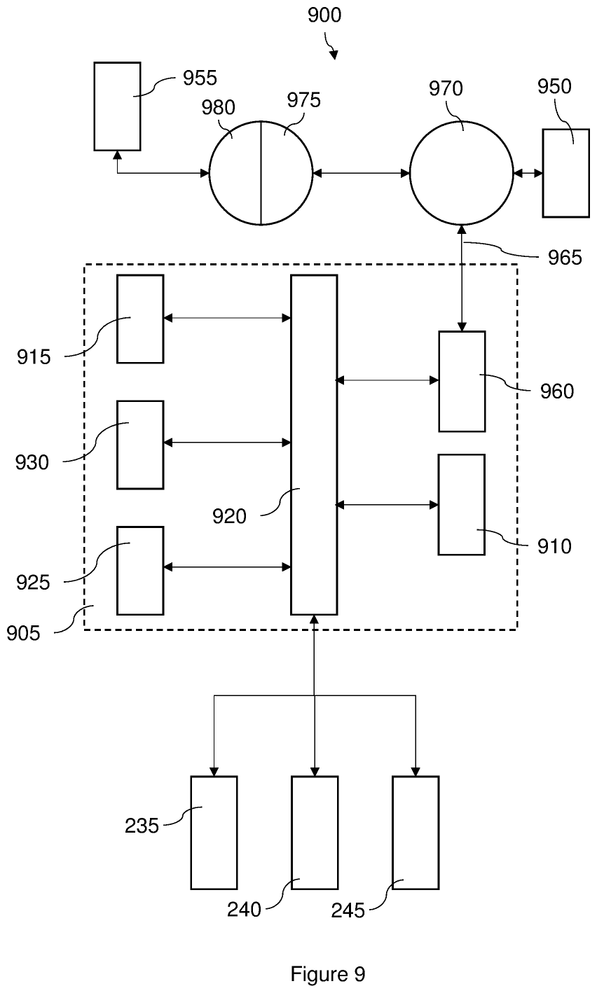

The data representative of the values sensed by at least one sensor, 110, 115, 116, 117, 118, 181, 182, 183, 184 and/or 500, is transmitted to a computing system 900, such as the one shown in FIG. 9.

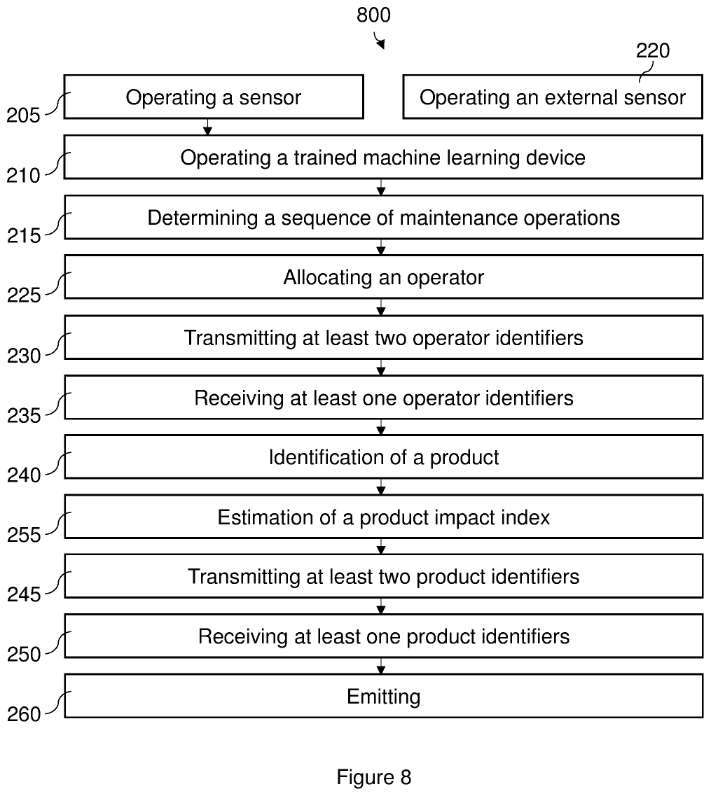

This computing system 900 comprises at least one processor 120 configured to execute instructions, which can correspond to a computer software, representative of at least the following steps, such as shown in FIG. 8:
operating 210 a trained machine learning model, said model being trained to associate, for at least one series of sensed value representative of a physical/chemical parameter, at least one aquatic installation operational degradation event associated with a date of event occurrence, and
determining 215 a sequence of maintenance operations to be performed on at least one aquatic installation as a function of at least one predicted aquatic installation operational degradation event and associated date of event occurrence.

During the step 210 of operating, a trained machine learning model obtained during a step (not represented) of training said machine learning model is applied to data generated by operating at least one sensor 110, 115, 116, 117, 118, 181, 182, 183, 184 and/or 500.

The type of machine learning device used to obtain the trained machine learning model can be of any type suited for the nature and format of the data generated by operating at least one sensor 110, 115, 116, 117, 118, 181, 182, 183, 184 and/or 500.

Such a machine learning device can operate at least one of the following types of machine learning methods:
supervised learning, in which the machine learning model is trained to predict an output based on an input, given a set of examples,
unsupervised learning, in which the machine learning model is trained to identify patterns in the data without any guidance,
semi-supervised learning, in which the machine learning model is trained on both labeled and unlabeled data,
reinforcement learning, in which the machine learning model is trained based on the rewards and punishments it receives for its actions, and/or
deep learning, in which the machine learning model is trained using artificial neural networks to learn and make decisions.

Such a machine learning device can operate at least one of the following types of deep learning methods:
Convolutional Neural Networks (CNNs), often used for image and video processing tasks, such as object recognition, image classification, and segmentation,
Recurrent Neural Networks (RNNs), often used for sequential data processing, such as natural language processing (NLP), speech recognition, and time-series analysis, and/or
Attention Models, often used for machine learning models model needing to selectively focus on different parts of the input.

Such a machine learning device may use ensemble neural networks, for example.

The output of the step 210 of operating is a list of at least one installation operational degradation event, that is an event requiring maintenance and preferably proactive maintenance, and dates of occurrence of said event.

Such an installation operational degradation event can correspond to, but is not limited to:
a low, critically-low or empty level of a consumable used in a water treatment circuit associated with the installation 111, and/or
a device malfunction or breakdown, said device belonging to a water treatment circuit associated with the installation 111, or interacting with said installation 111, and/or
a state of the water in the installation 111, said state being representative of an acidity or basicity level, or a water behavior (scaling or aggressive) for example, and/or
a low or high or inappropriate disinfection rate and/or high or inappropriate disinfection residue rate (such as combined chlorine when active chlorine is used as the main disinfected agent) in the installation 111, said rate being measure with dedicated sensors, with values which are lower or higher to the user's set point and/or to the tolerate values by local regulations and/or by the disinfection algorithms which adjust continuously the ideal values based on the aquatic installation uses and real time need, and/or
a low or high or inappropriate value of a chemical parameter, such as total alkalinity and/or pH and/or cyanuric acid content, and/or salt content, and/or phosphates compounds rate, and/or sulfates rates, and/or nitrates rates, and/or nitrites rates, and/or chlorates rates, and/or
a low or high or inappropriate pressure measured in the filter and/or in the pipes and/or in the filtration pump, and/or
a low or high or inappropriate flow measured in the filter and/or in the pipes and/or in the filtration pump, and/or
a leak detection, and/or
an overuse of water refill, and/or
a low or high level of water in the installation, and/or
an overconsumption of energy, and/or
a high turbidity in the aquatic installation, and/or
a high amount of particle presence in the aquatic installation, and/or
a spot and/or stain detection, and/or
a high number of metallic compounds, and/or
the number of users and/or bathers at the aquatic facility, and/or
a predicted or unpredicted weather change that may occur in the coming period, and/or
the impact of short and longer term climactic changes on the aquatic facilities ability to function correctly and according to control parameters, and/or
a water color change, and/or
a detected presence of unallowed object and/or animal, and/or
a temperature raising failure or a non-homogenous temperature in the water installation.

The output date of the step 210 of operating can be an absolute date (“march 3^{rd}”) or a relative date (“in a week”, “within 3 days”, “within 24 h”).

In more advanced embodiments, the step 210 of operating is configured to associate other parameters to an installation operational degradation event occurrence prediction. Such other parameters may correspond to, for example, a level of criticality of the event or the operating time to solve it.

In more advanced embodiments, the step 210 of operating is configured to associate several dates to an installation operational degradation event occurrence prediction. Such dates correspond to, for example, changes in criticality of the event such as, for example, the switch from a low level of a consumable to a critically low level or to an empty level.

The step 215 of determining a sequence of maintenance operations to be performed corresponds, for example, to a resource allocation algorithm. Such a resource allocation algorithm may be configured to schedule, that is organize in time, a sequence of maintenance operations.

Such an organization may be based solely on the predicted dates of occurrence of events obtained during the step 210 of operating.

In more advanced embodiments, such an organization may be based on secondary criteria, such as operator-event compatibility, product availability, geographical locations of the events and operating costs. Examples of such embodiments are disclosed below.

In particular embodiments, the at least one processor 120 is configured to execute instructions representative of a step 225 of allocating, for at least one predicted event in a sequence of maintenance operations, an operator identifier as a function of operator parameters associated with the operator identifier.

In simple embodiments, during the step 225 of allocating, each event in the sequence of events is associated to an event identifier and each operator is associated to an operator identifier.

An event identifier corresponds, for example, to a bijective code (such as an alphanumeric or binary code) which corresponds to the digital representation of an event. An event identifier may be associated to further information, such as the date of the event, a location of the event, a type of event and a status of the maintenance for the event, for example.

An operator identifier corresponds, for example, to a bijective code (such as an alphanumeric or binary code) which corresponds to the digital representation of an operator. An operator identifier may be associated to further information, such as the name of the operator, a type of events that the operator can process, a location of the operator and a status of the operator, for example.

This operator allocation can be automatic (entirely performed by a software), semi-automatic (based on suggestions by a software validated or overridden by a user) or manual (set by a user upon a graphical user interface for example).

The allocation may be materialized by the creation of a link (such as a key in a table in a database), in a memory, between an event identifier and an operator identifier.

Such an allocation may follow allocation rules, such as, for example:
an operator identifier cannot be associated to an event identifier if the operator identifier is associated to another event identifier at the same date and time or during an interval surrounding the associated event which cannot allow the operator to be totally available for the second event, and/or
an operator identifier cannot be associated to an event identifier if the event identifier is associated to a date that is below a determined threshold from the date of another event identifier already allocated to the operator that exceeds a determined threshold value from the location of said already allocated event.

In a multi-installation and multi-operator context, this means that a user and/or a software can allocate operators to the maintenance of installations on a many-to-many basis.

In particular embodiments, at least two operator identifiers are allocated during the step 225 of allocation, at least one processor 120 being configured to execute instructions representative of the steps of:
transmitting 230, to a third party computing system associated with an user identifier, at least two said operator identifiers, and
receiving 235, from a third party computing system associated with the user identifier, a selection of at least one of the at least two said operator identifiers.

The steps of transmitting 230 and receiving 235 may be performed using any communication means, or I/O subsystem such as shown in FIG. 9.

For example, during the step 230 of transmitting, a digital message comprising at least two said operator identifiers allocated to a predicted event, as well the event identifier, is sent to a computing system belonging, or associated to, a user identifier.

A user identifier corresponds, for example, to a bijective code (such as an alphanumeric or binary code) which corresponds to the digital representation of a user. A user identifier is typically associated to an aquatic facility owner or an aquatic facility manager in charge of several aquatic facilities.

The third party computing system corresponds to, for example, a computer or smartphone belonging to the user. The message may also correspond to a notification, via email for example, inviting the user to connect upon a facility management software comprising a graphical user interface. Such a facility management software may allow for several functionalities:
aquatic installation status monitoring, and/or
aquatic installation maintenance event predictions, and/or
operator allocation for maintenance events, and/or
product purchase and allocation for maintenance events, and/or
self-help resources to autonomously performing maintenance upon water installation.

Using the third-party computing system, a user selects at least one operator identifier to handle the aquatic installation operational degradation event.

For example, during the step 235 of receiving, a user input is registered upon a graphical user interface, said input being representative of a selection of at least one operator identifier. Such an input may be performed, for example, upon a smartphone or computer, triggering a selection of operator identifiers by the computing system 900.

In particular embodiments, at least one predicted event is associated with an event type identifier, at least one operator parameter representing an event type identifier operator compatibility.

Such an event type identifier corresponds, for example, to a bijective code (such as an alphanumeric or binary code) which corresponds to the digital representation of a type of degradation event. Examples of such types of degradation events are mentioned above. Other such examples may correspond to, for example:
hydraulic circuit events, and/or
consumable refill events, and/or
installation maintenance events, and/or
electric repair maintenance events, and/or
filter related maintenance events, and/or
pump related maintenance events, and/or
installation equipment maintenance events, and/or
installation equipment sensor maintenance events.

Each predicted aquatic installation operational degradation event may be associated with at least one event type identifier and each operator may be associated with at least one event type identifier. This operator and event type association may be performed in a facility management software in which operators may log in and set up their account as well as event type associations. Such associations may also be performed by facility managers or swimming pool owners by registering operators and associating event types to said operators.

In particular embodiments, the at least one processor 120 is configured to execute instructions representative of a step 240 of identification of at least one product identifier representative of a product to be used during the sequence of maintenance operations determined.

A product identifier corresponds, for example, to a bijective code (such as an alphanumeric or binary code) which corresponds to the digital representation of a product to be used in the context of the maintenance to be performed. A product identifier may correspond to a consumable or any aquatic installation equipment, for example.

The step 240 of identification may be performed by reading, in a memory, product identifiers proactively associated to aquatic installation operational degradation event identifiers. Such an association can be performed automatically, semi-automatically or manually by a user.

Such identified products may be communicated to a user of the system, typically a user associated with the aquatic installation 111 subject of the maintenance.

In particular embodiments, at least two product identifiers are identified during the step 240 of identification, at least one processor 120 being configured to execute instructions representative of the steps of:
transmitting 245, to a third-party computing system associated with a user identifier, at least two said product identifiers, and
receiving 250, from a third-party computing system associated with the user identifier, a selection of at least one of the at least two said product identifiers.

The steps of transmitting 245 and receiving 250 may function similarly to the steps of transmitting 230 at least two operator identifiers and the step 235 of receiving at least one operator identifier. Instead of selecting an operator, the user here selects a product.

In particular embodiments, the at least one processor 120 is configured to execute instructions representative of a step of estimation 255 of a product impact index, representative of the capacity of a product to resolve an aquatic installation operational degradation event, said index being associated with at least one identified product identifier and transmitted during the step of transmitting.

Such a step of estimation 255 may be performed, for example, by retrieving a product impact index from a product to event identifier matrix storing values representative of the impact of a particular product for a particular type of event. This product impact index is representative of the capacity of a particular product to qualitatively participate in resolving a particular event.

In particular embodiments, the at least one processor 120 is configured to execute instructions representative of a step of emitting 260, to a third-party computing system associated with at least one selected product identifier, a message representative of a purchase order of at least one product associated with the at least one selected product identifier.

Such a step of emitting 260 may be performed using an I/O subsystem or a communication means of a computing system 900 such as shown in FIG. 9.

The message emitted may further comprise information representative of a shipping location for the purchased product.

FIG. 2 represents, schematically, a particular succession of steps of the method 200 object of the present invention. This aquatic installation predictive maintenance method 200 comprises:
at least one step 205 of operating a physical/chemical sensor interacting with water in at least one aquatic installation to provide series of at least one sensed value representative of a physical/chemical parameter,
a step 210 of operating a trained machine learning model, said model being trained to associate, for at least one series of sensed value representative of a physical/chemical parameter, at least one aquatic installation operational degradation event associated with a date of event occurrence, and
a step 215 of determining a sequence of maintenance operations to be performed on at least one aquatic installation as a function of at least one predicted aquatic installation operational degradation event and associated date of event occurrence.

Particular embodiments of the steps of operating physical/chemical sensor 205, of operating 210 a trained machine learning model and of determining 215 are disclosed above.

FIG. 9 represents a block diagram that illustrates an example computer system 900 with which an embodiment may be implemented. In the example of FIG. 9, a computer system 905 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

The computer system 905 includes an input/output (IO) subsystem 920 which may include a bus and/or other communication mechanism(s) for communicating information and/or instructions between the components of the computer system 905 over electronic signal paths. The I/O subsystem 920 may include an I/O controller, a memory controller and at least one I/O port. The electronic signal paths are represented schematically in the drawings, for example as lines, unidirectional arrows, or bidirectional arrows.

At least one hardware processor 910 is coupled to the I/O subsystem 920 for processing information and instructions. Hardware processor 910 may include, for example, a general-purpose microprocessor or microcontroller and/or a special-purpose microprocessor such as an embedded system or a graphics processing unit (GPU) or a digital signal processor or ARM processor. Processor 910 may comprise an integrated arithmetic logic unit (ALU) or may be coupled to a separate ALU.

Computer system 905 includes one or more units of memory 925, such as a main memory, which is coupled to I/O subsystem 920 for electronically digitally storing data and instructions to be executed by processor 910. Memory 925 may include volatile memory such as various forms of random-access memory (RAM) or other dynamic storage device. Memory 925 also may be used for storing temporary variables or other intermediate information during execution of instructions to be executed by processor 910. Such instructions, when stored in non-transitory computer-readable storage media accessible to processor 910, can render computer system 905 into a special-purpose machine that is customized to perform the operations specified in the instructions.

Computer system 905 further includes non-volatile memory such as read only memory (ROM) 930 or other static storage device coupled to the I/O subsystem 920 for storing information and instructions for processor 910. The ROM 930 may include various forms of programmable ROM (PROM) such as erasable PROM (EPROM) or electrically erasable PROM (EEPROM). A unit of persistent storage 915 may include various forms of non-volatile RAM (NVRAM), such as FLASH memory, or solid-state storage, magnetic disk, or optical disk such as CD-ROM or DVD-ROM and may be coupled to I/O subsystem 920 for storing information and instructions. Storage 915 is an example of a non-transitory computer-readable medium that may be used to store instructions and data which when executed by the processor 910 cause performing computer-implemented methods to execute the techniques herein.

The instructions in memory 925, ROM 930 or storage 915 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 905 may be coupled via I/O subsystem 920 to at least one output device 935. In one embodiment, output device 935 is a digital computer display or Human Machine Interface. Examples of a display that may be used in various embodiments include a touch screen display or a light-emitting diode (LED) display or a liquid crystal display (LCD) or an e-paper display. Computer system 905 may include other type(s) of output devices 935, alternatively or in addition to a display device. Examples of other output devices 935 include printers, ticket printers, plotters, projectors, sound cards or video cards, speakers, buzzers or piezoelectric devices or other audible devices, lamps or LED or LCD indicators, haptic devices, actuators, or servos.

At least one input device 940 is coupled to I/O subsystem 920 for communicating signals, data, command selections or gestures to processor 910. Examples of input devices 940 include touch screens, microphones, still and video digital cameras, alphanumeric and other keys, keypads, keyboards, graphics tablets, image scanners, joysticks, clocks, switches, buttons, dials, slides.

Another type of input device is a control device 945, which may perform cursor control or other automated control functions such as navigation in a graphical interface on a display screen, alternatively or in addition to input functions. Control device 945 may be a touchpad, a mouse, a trackball, or cursor direction keys for communicating direction information and command selections to processor 910 and for controlling cursor movement on display 935. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 940 may include a combination of multiple different input devices, such as a video camera and a depth sensor.

In another embodiment, computer system 905 may comprise an internet of things (IoT) device in which one or more of the output device 935, input device 940, and control device 945 are omitted. Or, in such an embodiment, the input device 940 may comprise one or more cameras, motion detectors, thermometers, microphones, seismic detectors, other sensors or detectors, measurement devices or encoders and the output device 935 may comprise a special-purpose display such as a single-line LED or LCD display, one or more indicators, a display panel, a meter, a valve, a solenoid, an actuator or a servo.

Computer system 905 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 905 in response to processor 910 executing at least one sequence of at least one instruction contained in main memory 925. Such instructions may be read into main memory 925 from another storage medium, such as storage 915. Execution of the sequences of instructions contained in main memory 925 causes processor 910 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 915. Volatile media includes dynamic memory, such as memory 925. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 920. Transmission media can also take the form of acoustic or light waves, such as those generated during radio-wave and infra-red data communications.

Various forms of media may be involved in carrying at least one sequence of at least one instruction to processor 910 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 905 can receive the data on the communication link and convert the data to a format that can be read by computer system 905. For instance, a receiver such as a radio frequency antenna or an infrared detector can receive the data carried in a wireless or optical signal and appropriate circuitry can provide the data to I/O subsystem 920 such as place the data on a bus. I/O subsystem 920 carries the data to memory 925, from which processor 910 retrieves and executes the instructions. The instructions received by memory 925 may optionally be stored on storage 915 either before or after execution by processor 910.

Computer system 905 also includes a communication interface 960 coupled to bus 920. Communication interface 960 provides a two-way data communication coupling to network link(s) 965 that are directly or indirectly connected to at least one communication network, such as a network 970 or a public or private cloud on the Internet. For example, communication interface 960 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 970 broadly represents a local area network (LAN), wide-area network (WAN), campus network, internetwork, or any combination thereof. Communication interface 960 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 960 sends and receives electrical, electromagnetic, or optical signals over signal paths that carry digital data streams representing various types of information.

Network link 965 typically provides electrical, electromagnetic, or optical data communication directly or through at least one network to other data devices, using, for example, satellite, cellular, Wi-Fi, or BLUETOOTH technology. For example, network link 965 may provide a connection through a network 970 to a host computer 950.

Furthermore, network link 965 may provide a connection through network 970 or to other computing devices via internetworking devices and/or computers that are operated by an Internet Service Provider (ISP) 975. ISP 975 provides data communication services through a world-wide packet data communication network represented as internet 980. A server computer 955 may be coupled to internet 980. Server 955 broadly represents any computer, data center, virtual machine, or virtual computing instance with or without a hypervisor, or computer executing a containerized program system such as DOCKER or KUBERNETES. Server 955 may represent an electronic digital service that is implemented using more than one computer or instance and that is accessed and used by transmitting web services requests, uniform resource locator (URL) strings with parameters in HTTP payloads, API calls, app services calls, or other service calls. Computer system 905 and server 955 may form elements of a distributed computing system that includes other computers, a processing cluster, server farm or other organization of computers that cooperate to perform tasks or execute applications or services. Server 955 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 955 may comprise a web application server that hosts a presentation layer, application layer and data storage layer such as a relational database system using structured query language (SQL) or no SQL, an object store, a graph database, a flat file system or other data storage.

Computer system 905 can send messages and receive data and instructions, including program code, through the network(s), network link 965 and communication interface 960. In the Internet example, a server 955 might transmit a requested code for an application program through Internet 980, ISP 975, local network 970 and communication interface 960. The received code may be executed by processor 910 as it is received, and/or stored in storage 915, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 910. While each processor 910 or core of the processor executes a single task at a time, computer system 905 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### OBJECT OF THE INVENTION

The present invention is intended to remedy all or part of the disadvantages of the prior art.

To this effect, according to a first aspect, the present invention aims at an aquatic installation predictive maintenance system, comprising:
at least one physical/chemical sensor interacting with water in at least one aquatic installation and configured to provide series of at least one sensed value representative of a physical/chemical parameter, and
at least one processor configured to execute instructions representative of the steps of:
   operating a trained machine learning model, said model being trained to associate, for at least one series of sensed value representative of a physical/chemical parameter, at least one aquatic installation operational degradation event associated with a date of event occurrence, and
   determining a sequence of maintenance operations to be performed on at least one aquatic installation as a function of at least one predicted aquatic installation operational degradation event and associated date of event occurrence.

Such provisions allow for both the accurate prediction of a future need for maintenance of one or more aquatic facilities and the optimized sequence of maintenance operations to reduce the short-term and long-term risks of lasting degradations to the installation or the water contained within.

In particular embodiments, the system object of the present invention comprises a submersible and/or floating vehicle, comprising at least one said physical/chemical sensor and/or a pipe of a circulation system where water flows, and/or in an analysis chamber comprising at least one said physical/chemical sensor, configured to provide a measure of a local physical/chemical parameter in the proximity of the submersible and/or floating vehicle and/or in the circulation system of the aquatic installation

Such provisions allow for the accurate determination of issues and risks associated with the water in the installation and/or with the installation itself. The ability to use a mobile vehicle onboarding sensors allows for greater flexibility on the positioning of said sensors in relation to a particular physical/chemical value to be analyzed. The adequation between positioning and measurement ensures greater accuracy of the results and improved diagnostics capabilities.

In particular embodiments, the submersible and/or floating vehicle comprises an optical sensor, configured to provide a graphical representation of the water and/or aquatic installation, said representation being used during the step of operating the trained machine learning model.

In particular embodiments, at least one physical/chemical sensor may be:
a pH sensor, and/or
a total alkalinity sensor, and/or
a conductivity sensor, and/or
an oxidation-reduction potential sensor, and/or
a turbidity sensor, and/or
a temperature sensor, and/or
a flow sensor, and/or
an optical sensor, and/or
a camera and/or video camera, and/or
an acoustic and/or sonar sensor, and/or
a water movement sensor, and/or
a pressure sensor.

In particular embodiments, at least one physical/chemical sensor is an aquatic total alkalinity measurement device, comprising:
a pH probe configured to measure pH at the boundary layer of a body of water,
optionally, a floating reference device in proximity of the pH probe,
a probe controller, configured to sequentially activate and deactivate, or connect and disconnect, the pH probe,
a pH measurement variation detection device, configured to detect a variation of pH measurement in a sequence of pH probe measurements, and
an aquatic total alkalinity value determination device, configured to determine an aquatic total alkalinity value of the body of water as a function of the pH measurement variation detected.

Such provisions allow for the accurate and near real-time measurement of a total alkalinity value of a body of water at an inexpensive cost and with ordinary equipment. However, the benefits of this invention result from the counter-intuitive discovery, by the inventors, that switching the pH probe on and off when the water is not flowing provides an accurate total alkalinity measurement whereas continuous pH measurement does not. This is because the successive activation/deactivation, or connection/disconnection of the pH probe results in a chemical reaction taking place in the vicinity of the pH probe. This chemical reaction results in a variation in pH measurement, said variation being dependent on the total alkalinity value of the water in the vicinity of the pH probe off, when the water is not flowing. Therefore, the present invention allows for the determination of the total alkalinity value of a body of water without using a total alkalinity measurement sensor. Such an indirect measurement significantly improves the capacity to measure total alkalinity in aquatic facilities and in any other water storage and management systems.

In particular embodiments, the system object of the present invention comprises an external parameter sensor, the trained model being configured to associate, for at least one series of sensed value representative of a physical/chemical parameter and at least one series of external parameter sensed, at least one aquatic installation operational degradation event associated with a date of event occurrence.

Such embodiments allow for the training of the machine learning model to recognize patterns that involve external parameters, such as the weather, air pollution, a number of bathers in the aquatic installation, external image acquisition, or air temperature for example.

In particular embodiments, the at least one processor is configured to execute instructions representative of a step of allocating, for at least one predicted event in a sequence of maintenance operations, an operator identifier as a function of operator parameters associated with the operator identifier.

Such embodiments allow for the dynamic and efficient allocation of human resources to the maintenance of the aquatic installation.

In particular embodiments, at least two operator identifiers are allocated during the step of allocation, at least one processor being configured to execute instructions representative of the steps of:
transmitting, to a third-party computing system associated with a user identifier, at least two said operator identifiers, and
receiving, from a third-party computing system associated with the user identifier, a selection of at least one of the at least two said operator identifiers.

Such embodiments allow for the selection, by a managing user, of the operator in charge of the maintenance. Such a selection may be based upon financial cost, distance, or experience of the operator for example.

In particular embodiments, at least one predicted event is associated with an event type identifier, at least one operator parameter representing an event type identifier operator compatibility.

Such embodiments allow for the selection, by a managing user, of the operator in charge of the maintenance based upon the compatibility (expertise) of said operator with the maintenance event predicted.

In particular embodiments, the at least one processor is configured to execute instructions representative of a step of identification of at least one product identifier representative of a product to be used during the sequence of maintenance operations determined.

Such embodiments allow for the identification of products that can mitigate the severity of the maintenance event predicted or allow for the maintenance to be completed.

In particular embodiments, at least two product identifiers are identified during the step of identification, at least one processor being configured to execute instructions representative of the steps of:
transmitting, to a third-party computing system associated with a user identifier, at least two said product identifiers, and
receiving, from a third-party computing system associated with the user identifier, a selection of at least one of the at least two said product identifiers.

Such embodiments allow for the selection, by a managing user, of the product to be used for the maintenance. Such a selection may be based upon financial cost, distance, or quality of the product for example.

In particular embodiments, the at least one processor is configured to execute instructions representative of a step of estimation of a product impact index, representative of the capacity of a product to resolve an aquatic installation operational degradation event, said index being associated with at least one identified product identifier and transmitted during the step of transmitting.

Such embodiments allow for the selection, by a managing user, of the product to be used for the maintenance based upon the likelihood of positive impact of the product upon the maintenance event predicted.

In particular embodiments, the at least one processor is configured to execute instructions representative of a step of emitting, to a third-party computing system associated with at least one selected product identifier, a message representative of a purchase order of at least one product associated with the at least one selected product identifier.

Such embodiments allow for the automatic acquisition of the product selected and shipment to the aquatic installation.

In particular embodiments, at least one physical/chemical sensor is associated with geographical coordinates, the step of determining a sequence being configured to further determine a sequence as a function of geographical coordinates of aquatic facilities associated with at least one predicted aquatic installation operational degradation event.

Such embodiments allow for the dynamic and efficient allocation of operators and resources to optimize the logistics of said resources.

According to a second aspect, the present invention aims at an aquatic installation predictive maintenance method, comprising:
at least one step of operating a physical/chemical sensor interacting with water in at least one aquatic installation to provide series of at least one sensed value representative of a physical/chemical parameter,
a step of operating a trained machine learning model, said model being trained to associate, for at least one series of sensed value representative of a physical/chemical parameter, at least one aquatic installation operational degradation event associated with a date of event occurrence, and
a step of determining a sequence of maintenance operations to be performed on at least one aquatic installation as a function of at least one predicted aquatic installation operational degradation event and associated date of event occurrence.

The method object of the present invention provides the same advantages as the system object of the present invention.

1. Aquatic installation predictive maintenance system, comprising:
at least one physical/chemical sensor interacting with water in at least one aquatic installation and configured to provide series of at least one sensed value representative of a physical/chemical parameter, and
at least one processor configured to execute instructions representative of the steps of:
operating a trained machine learning model, said model being trained to associate, for at least one series of sensed value representative of a physical/chemical parameter, at least one aquatic installation operational degradation event associated with a date of event occurrence, and
determining a sequence of maintenance operations to be performed on at least one aquatic installation as a function of at least one predicted aquatic installation operational degradation event and associated date of event occurrence.

2. System according to claim 1, which comprises a submersible and/or floating vehicle, comprising at least one said physical/chemical sensor and/or a pipe of a circulation system where water flows, and/or in an analysis chamber comprising at least one said physical/chemical sensor, configured to provide a measure of a local physical/chemical parameter in the proximity of the submersible and/or floating vehicle and/or in the circulation system of the aquatic installation.

3. System according to claim 2, in which the submersible and/or floating vehicle comprises an optical sensor, configured to provide a graphical representation of the water and/or aquatic installation, said representation being used during the step of operating the trained machine learning model.

4. System according to claim 1, in which at least one physical/chemical sensor is:
a pH sensor, and/or
a total alkalinity sensor, and/or
a conductivity sensor, and/or
an oxidation-reduction potential sensor, and/or
a turbidity sensor, and/or
a temperature sensor, and/or
a flow sensor, and/or
an optical sensor, and/or
a camera and/or video camera, and/or
an acoustic and/or sonar sensor, and/or
a water movement sensor, and/or
a pressure sensor.

5. System according to claim 1, in which at least one physical/chemical sensor is an aquatic total alkalinity measurement device, comprising:
a pH probe configured to measure pH at the boundary layer of a body of water,
a probe controller, configured to sequentially activate and deactivate, or connect and disconnect, the pH probe,
a pH measurement variation detection device, configured to detect a variation of pH measurement in a sequence of pH probe measurements, and
an aquatic total alkalinity value determination device, configured to determine an aquatic total alkalinity value of the body of water as a function of the pH measurement variation detected.

6. System according to claim 1, which comprises an external parameter sensor, the trained model being configured to associate, for at least one series of sensed value representative of a physical/chemical parameter and at least one series of external parameter sensed, at least one aquatic installation operational degradation event associated with a date of event occurrence.

7. System according to claim 1, in which the at least one processor is configured to execute instructions representative of a step of allocating, for at least one predicted event in a sequence of maintenance operations, an operator identifier as a function of operator parameters associated with the operator identifier.

8. System according to claim 7, in which at least two operator identifiers are allocated during the step of allocation, at least one processor being configured to execute instructions representative of the steps of:
transmitting, to a third-party computing system associated with a user identifier, at least two said operator identifiers, and
receiving, from a third-party computing system associated with the user identifier, a selection of at least one of the at least two said operator identifiers.

9. System according to claim 7, in which at least one predicted event is associated with an event type identifier, at least one operator parameter representing an event type identifier operator compatibility.

10. System according to claim 1, in which the at least one processor is configured to execute instructions representative of a step of identification of at least one product identifier representative of a product to be used during the sequence of maintenance operations determined.

11. System according to claim 10, in which at least two product identifiers are identified during the step of identification, at least one processor being configured to execute instructions representative of the steps of:
transmitting, to a third-party computing system associated with a user identifier, at least two said product identifiers, and
receiving, from a third-party computing system associated with the user identifier, a selection of at least one of the at least two said product identifiers.

12. System according to claim 11, in which the at least one processor is configured to execute instructions representative of a step of estimation of a product impact index, representative of the capacity of a product to resolve an aquatic installation operational degradation event, said index being associated with at least one identified product identifier and transmitted during the step of transmitting.

13. System according to claim 11, in which the at least one processor is configured to execute instructions representative of a step of emitting, to a third-party computing system associated with at least one selected product identifier, a message representative of a purchase order of at least one product associated with the at least one selected product identifier.

14. System according to claim 1, in which at least one physical/chemical sensor is associated with geographical coordinates, the step of determining a sequence being configured to further determine a sequence as a function of geographical coordinates of aquatic facilities associated with at least one predicted aquatic installation operational degradation event.

15. Aquatic installation predictive maintenance method, comprising:
at least one step of operating a physical/chemical sensor interacting with water in at least one aquatic installation to provide series of at least one sensed value representative of a physical/chemical parameter,
a step of operating a trained machine learning model, said model being trained to associate, for at least one series of sensed value representative of a physical/chemical parameter, at least one aquatic installation operational degradation event associated with a date of event occurrence, and
a step of determining a sequence of maintenance operations to be performed on at least one aquatic installation as a function of at least one predicted aquatic installation operational degradation event and associated date of event occurrence.
